(19) United States
(12) Patent Application Publication
(10) Pub. No.: US 2023/0212069 A1
(43) Pub. Date: Jul. 6, 2023

(54) A METHOD FOR MANUFACTURING MAN-MADE VITREOUS FIBRES

(71) Applicant: ROCKWOOL A/S, Hedehusene (DK)

(72) Inventors: Rob DEKKERS, Hedehusene (DK); Alfred LEHNEN, Hedehusene (DK); Mathijs TEN HAAFT, Hedehusene (DK)

(21) Appl. No.: 18/000,536

(22) PCT Filed: Jun. 1, 2021
(86) PCT No.: PCT/EP2021/064627

§ 371 Date: Dec. 2, 2022

(30) Foreign Application Priority Data
Jun. 3, 2020 (EP) 20178059.0

(51) Int. Cl. C03C 25/66; C03B 37/02; C03C 25/34; C03C 13/06; D04H 1/4218; D04H 1/58

(52) U.S. Cl. CPC C03C 25/66; C03B 37/02; C03C 25/34; C03C 13/06; D04H 1/4218; D04H 1/58; C03C 2213/00; D10B 2401/063

(57) ABSTRACT

The invention relates to a method for manufacturing water treated man-made vitreous fibres (MMVF) comprising:

a. providing a mineral melt,

b. providing a fiberizing apparatus,

c. fiberizing the mineral melt to form man-made vitreous fibres (MMVF),

d. collecting the MMVF, and thereafter

e. applying about 0.1 wt % to about 1 wt % water, based on the weight of the MMVF, to the MMVF to form water treated MMVF.

The present invention relates to a method for manufacturing water treated man-made vitreous fibres and a method of manufacturing a man-made vitreous fibre element.

### BACKGROUND TO THE INVENTION

It is known to use man-made vitreous fibres (MMVF) to make MMVF elements such as boards, panels, and slabs. MMVF are typically bound with a cured binder composition to make the MMVF elements. The MMVF elements can be used as insulation materials and cladding.

There is a need for an improved method for manufacturing MMVF. There is a need for an environmentally friendly method of manufacture. There is a need to reduce the storage time required to condition MMVF. There is a need to reduce the packaging required for a bale of MMVF. There is a need to reduce the amount of binder used in MMVF elements while maintaining the aged bending strength. There is a need to reduce the density of MMVF elements to save on raw materials and transportation costs. There is a need to increase the aged bending strength of MMVF elements. There is a need to increase the fire class of MMVF elements. It is, therefore, an object of the present invention to seek to alleviate the above identified problems.

### SUMMARY OF THE INVENTION

According to a first aspect of the present invention, there is provided a method for manufacturing water treated man-made vitreous fibres (MMVF) comprising:
a. providing a mineral melt,
b. providing a fiberizing apparatus,
c. fiberizing the mineral melt to form man-made vitreous fibres (MMVF),
d. collecting the MMVF, and thereafter
e. applying about 0.1 wt % to about 1 wt % water, based on the weight of MMVF, to the MMVF to form water treated MMVF.

According to a second aspect of the present invention, there is provided a bale, mat or collection of loose fibres comprising water treated man-made vitreous fibres manufactured according to the first aspect of the invention.

According to a third aspect of the invention, there is provided a method of manufacturing a man-made vitreous fibre element (MMVF element), comprising:
i. providing water treated man-made vitreous fibres (MMVF) manufactured according to the first aspect of the invention,
ii. providing a binder,
iii. applying the binder to the MMVF to form a mixture,
iv. shaping the mixture,
v. curing the mixture to form the MMVF element.

### DETAILED DESCRIPTION

The present invention relates to a method for manufacturing water treated man-made vitreous fibres (MMVF) comprising:
a. providing a mineral melt,
b. providing a fiberizing apparatus,
c. fiberizing the mineral melt to form man-made vitreous fibres (MMVF),
d. collecting the MMVF, and thereafter applying about 0.1 wt % to about 1 wt % water, based on the weight of MMVF, to the MMVF to form water treated MMVF.

It is an advantage of the present invention that it provides an improved method for manufacturing MMVF. The use of water in the process is environmentally friendly as there is not a requirement for additional chemicals to be used. Surprisingly, it has been found that the water treated MMVF can be stored for a shorter period of time than untreated MMVF before using them. The conditioning occurs at a faster rate with the MMVF of the invention. This has the advantage of a more rapid manufacture process and a reduction in the storage capacity required. Furthermore, it allows MMVF to be produced closer to the time they are used, which means any peaks and troughs in demand for the fibres can be more easily managed which reduces waste and energy usage. It is known that MMVF age overtime and it is a particular advantage of the invention that conditioning occurs more rapidly.

It will be appreciated that the water treatment causes a change in the MMVF and/or its surface.

It is known to use water as a coolant as part of the process for forming MMVF, however the water is applied during the formation of the MMVF, such as in a spinning cup or a cascade spinner and prior to the collection of the MMVF. Water used as a coolant prior to collection of the MMVF is therefore different to water treatment step e. The inventors have found that the introduction of water during the fiberisation process, such as into a spinning cup or cascade spinner does not result in the advantages of the invention. It is clear therefore, that it is necessary to collect the MMVF as set out in step d.

Preferably a proportion of the water will evaporate from the MMVF after step e.

The MMVF made by the present invention are easier to form into bales and in particular do not need to be completely or partially covered by a material such as cardboard or plastic. Surprisingly, the bales hold their shape when bound by a wire or rope alone. Preferably substantially all of the surface area of the bale is not covered. Surprisingly, bales of water treated MMVF are denser than untreated MMVF.

Preferably, in step e, the temperature of the MMVF is in the range of about 10° C. to about 100° C., preferably about 30° C. to about 90° C., preferably about 50° C. to about 80° C. It is an advantage that the MMVF can be treated at a wide range of temperatures. This allows the water treatment step to fit in with an existing manufacturing method and does not require excessive cooling or heating to be carried out.

Preferably, in step e, the temperature of the water is in the range of about 10° C. to about 100° C., preferably about 30° C. to about 90° C., preferably about 50° C. to about 80° C. Such temperatures are convenient for manufacture.

Preferably, in step e the water is saturated steam. This provides an efficient way to apply the water. Advantageously, the saturated steam can be produced using heat from the manufacturing process. This circular use is environmentally friendly.

Preferably, in step e, the temperature of the MMVF is greater than the temperature of the water. This facilitates the water treatment step. Without being bound by theory, it is believed that a higher temperature of MMVF reduces the reaction time between the water and the MMVF and increases the evaporation of the water.

Preferably, step e comprises applying about 0.2 wt % to about 0.8 wt % water, based on the weight of the MMVF, to the MMVF to form water treated MMVF, preferably about 0.3 wt % to about 0.5 wt % water. It is advantageous to control the amount of water used in the process to balance the need to reduce water consumption while enabling the advantages of the invention.

Preferably, a mineral charge is provided and melted in a furnace to form the mineral melt.

Preferably, in step c, the mineral melt is fiberized by a spinning cup or a cascade spinner. These are known in the art of making MMVF.

Preferably, in step c, the MMVF are cooled prior to step d. Optionally, water is used as part of the cooling process, preferably to cool the machinery and preferably the air flow. It will be appreciated that any water used for cooling, is different to the water treatment applied in step e after the MMVF have been collected in step d.

Preferably, the steps are sequential. It will be appreciated that step d occurs before step e.

Preferably steps a to e are continuous, preferably the steps are carried out in line.

Preferably, in step d, collected means aggregated, such that a plurality of MMVF form a collection of MMVF.

Preferably, in step d, the MMVF are collected on a belt, preferably a conveyor belt. The MMVF are preferably directly conveyed on the belt to the water treatment step e.

Preferably the MMVF remain substantially in the same position relative to adjacent MMVF after they are collected in step d and prior to step e.

Preferably, step e occurs about 1 second to about 15 minutes after the MMVF have been collected in step d, preferably about 10 seconds to about 10 minutes, preferably 1 minute to about 5 minutes. Preferably, the water treatment step e is provided in line when the MMVF are formed. This results in an efficient process.

Preferably after step d and before and during step e, the MMVF are subjected to a disentanglement process.

Preferably after step d and before or during step e, the MMVF are subjected to a disentanglement process.

Preferably, after step d, and during water treatment step e, the MMVF are subjected to a disentanglement process.

Preferably the disentanglement process is an airstream. Preferably the airstream has an airflow of from about 1 m/s to about 150 m/s, preferably about 5 m/s to about 80 m/s. Disentanglement helps a uniform distribution of the MMVF and thus a uniform distribution of the water treatment.

Preferably the disentanglement process is as described in WO2011/012712, which is incorporated herein by reference in its entirety.

Preferably, in step d, the MMVF are in the form of:
A. a web, preferably wherein the web has a thickness in the range of about 5 cm to about 30 cm, preferably about 10 cm to about 20 cm, or
B. tufts, or
C. loose fibres.

Preferably, in step d, the MMVF are in the form of a web. A web is an efficient way to make MMVF. A web can be rolled up for storage, or split into tufts when needed. In a web, the fibres are not bound together with a binder, but are entangled with adjacent fibres to form a mass of fibres. A web is wider and/or longer than its thickness. The thickness of a web is preferably measured perpendicular to the surface it has been formed on.

Preferably the web is rotated about a longitudinal axis during step e. This helps the application of the water to the MMVF.

Preferably, in step d, the MMVF are in the form of a tuft. In a tuft, the fibres are not bound together with a binder, but are entangled with adjacent fibres to form a mass of fibres. A tuft may typically have a height, length, and width each independently in the range of about 5 mm to about 25 mm, preferably about 5 mm to about 20 mm. A tuft preferably has an irregular shape.

Preferably, the tufts are tumbled when the water is applied during step e. This helps the application of the water to the MMVF.

Preferably, in step d, the MMVF are in the form of loose fibres. Loose fibres are a collection of fibres which are not bound together with a binder and can be separated into individual fibres.

Preferably, the loose fibres are tumbled when the water is applied during step e. This helps the application of the water to the MMVF.

Preferably, in step e, the water is applied by spraying, preferably using a piezoelectric sprayer, an electrostatic sprayer, an ultrasonic sprayer, or a pressure sprayer. These produce water with a high surface area which helps the water to treat the MMVF.

Preferably, in step e, the top surface of the MMVF is sprayed with water and the MMVF are tumbled or rotated. Preferably, the MMVF are tumbled or rotated during step e. This helps the water to be applied to the MMVF in a consistent manner.

Preferably, in step e, the water spraying is applied by at least about one hydraulic nozzle, preferably about one to about eight hydraulic nozzles, preferably about two to about six hydraulic nozzles. This helps the water to be applied to the MMVF in a consistent manner.

Preferably, in step e, the water spraying is applied by at least about one group of hydraulic nozzles, preferably about two to about four groups of hydraulic nozzles. Preferably each group of hydraulic nozzles has about one to about eight hydraulic nozzles, preferably about two to about six hydraulic nozzles. This helps the water to be applied to the MMVF in a consistent manner.

Preferably, in step e, the water is treated water, preferably chemically and/or physically treated water, preferably filtered or purified water, preferably ion-exchange water. This has the advantage of reducing any impurities in the water.

Preferably, in step e, the water is collected from precipitation, preferably filtered precipitation. It is environmentally friendly to recycle precipitation in this method. Precipitation includes rain, sleet, snow, and hail, preferably rain.

Preferably, in step e, the water is not applied directly by precipitation, such as by being left outside, such as in the rain. This would not allow the amount of water being applied to be controlled.

Preferably, in step e, the water is in the form of droplets, preferably wherein the droplet size is about 10 μm to about 500 μm, preferably about 100 μm to about 300 μm. Droplets allow the water to be accurately applied to the MMVF and to cover a large surface area of MMVF. Droplets also allow a substantially even amount of water to be applied to the fibres.

Preferably, the MMVF are stone wool fibres or glass fibres, preferably stone wool fibres. Such materials are known to make MMVF.

Preferably, the MMVF have a diameter in the range of about 2 μm to about 10 μm, preferably about 2 μm to about 5 μm, more preferably about 3 μm to about 4 μm. Such diameters are suitable for use in MMVF elements.

The man-made vitreous fibres (MMVF) can have any suitable oxide composition. The fibres can be glass fibres, ceramic fibres, basalt fibres, slag fibres or rock or stone fibres. The fibres are preferably of the types generally known as rock, stone or slag fibres, most preferably stone fibres.

Stone fibres commonly comprise the following oxides, in percent by weight:

SiO₂: 30 to 51

CaO: 8 to 30

MgO: 2 to 25

FeO (including Fe₂O₃): 2 to 15

Na₂O+K₂O: not more than 10

CaO+MgO: 10 to 30

In preferred embodiments the MMVF have the following levels of elements, calculated as oxides in wt %:

SiO₂: at least 30, 32, 35 or 37; not more than 51, 48, 45 or 43

Al₂O₃: at least 12, 16 or 17; not more than 30, 27 or 25

CaO: at least 8 or 10; not more than 30, 25 or 20

MgO: at least 2 or 5; not more than 25, 20 or 15

FeO (including Fe₂O₃): at least 4 or 5; not more than 15, 12 or 10

FeO+MgO: at least 10, 12 or 15; not more than 30, 25 or 20

Na₂O+K₂O: zero or at least 1; not more than 10

CaO+MgO: at least 10 or 15; not more than 30 or 25

TiO₂: zero or at least 1; not more than 6, 4 or 2

TiO₂+FeO: at least 4 or 6; not more than 18 or 12

B₂O₃: zero or at least 1; not more than 5 or 3

P₂O₅: zero or at least 1; not more than 8 or 5

Others: zero or at least 1; not more than 8 or 5

The MMVF made by the method of the invention preferably have the following levels of elements, calculated as oxides in wt %:

| | |
|---|---|
| SiO₂ | 35 to 50 |
| Al₂O₃ | 12 to 30 |
| TiO2 | up to 2 |
| Fe₂O₃ | 3 to 12 |
| CaO | 5 to 30 |
| MgO | up to 15 |
| Na₂O | 0 to 15 |
| K₂O | 0 to 15 |
| P₂O₅ | up to 3 |
| MnO | up to 3 |
| B₂O₃ | up to 3 |

Another preferred composition for the MMVF have the following levels of elements, calculated as oxides in wt %:

SiO₂ 39-55% preferably 39-52%

Al₂O₃16-27% preferably 16-26%

CaO 6-20% preferably 8-18%

MgO 1-5% preferably 1-4.9%

Na₂O 0-15% preferably 2-12%

K₂O 0-15% preferably 2-12%

R₂O(Na₂O+K₂O) 10-14.7% preferably 10-13.5%

P₂O₅ 0-3% preferably 0-2%

Fe₂O₃ (iron total) 3-15% preferably 3.2-8%

B₂O₃ 0-2% preferably 0-1%

TiO₂ 0-2% preferably 0.4-1%

Others 0-2.0%

Glass fibres commonly comprise the following levels of elements, calculated as oxides in wt %:

SiO₂: 50 to 70

Al₂O₃: 10 to 30

CaO: not more than 27

MgO: not more than 12

Glass fibres can also contain the following levels of elements, calculated as oxides in wt %:

Na₂O+K₂O: 8 to 18, in particular Na₂O+K₂O greater than CaO+MgO

B₂O₃: 3 to 12.

Some glass fibre compositions can contain Al₂O₃: less than 2%.

In preferred embodiments the MMVF have the following levels of elements, calculated as oxides in wt %:

| | |
|---|---|
| SiO₂ | about 36 to about 41 |
| Al₂O₃ | about 18 to about 23 |
| TiO₂ | about 0.1 to about 2 |
| Fe₂O₃ | about 0.5 to about 2 |
| CaO + MgO | about 35 to about 40 |
| K₂O + Na₂O | about 0.5 to about 3 |
| P₂O₅ | about 0 to about 1 |
| MnO | about 0.5 to about 2. |

It will be appreciated that the amount of Fe₂O₃ quoted may include iron present as FeO.

Preferably a binder is not used in the method of manufacturing water treated MMVF as described herein.

Preferably, the method further comprises
f. forming the water treated MMVF into a bale.

A bale is a suitable way to store the MMVF. It is advantageous to store the MMVF to condition them.

Preferably, the bale can be formed from a web of MMVF, preferably wherein the web is rolled up to form the bale.

Preferably, the bale can be formed from tufts.

Preferably, the MMVF in the form of tufts or loose fibres can be stored in a container, preferably a silo. This provides a manageable way to store the MMVF.

Preferably, the method further comprises storing the MMVF for at least about 1 day, preferably about one day to about six weeks, preferably about 3 days to about 3 weeks. This allows the fibres to be conditioned. Surprisingly, the storage time can be reduced for MMVF of the invention compared to the prior art, whilst still achieving the required properties.

Preferably, the method comprises storing the MMVF at a temperature in the range of about 10° C. to about 100° C., preferably about 20° C. to about 75° C., preferably about 20° C. to about 50° C. These temperatures are suitable for storing the fibres.

Preferably, the method comprises storing the MMVF at an absolute humidity of about 1.8 g/m³ to about 600 g/m³, preferably about 5 g/m³ to about 200 g/m³. Absolute humidity refers to the grams of water moisture per cubic meter of air. These conditions are suitable for conditioning the fibres.

Preferably the MMVF are stored in the form of a bale, a mat, or loose fibres and/or tufts in a container, preferably in the form of a bale. These are suitable ways to store the MMVF for use.

The invention relates to a bale, mat or collection of loose fibres comprising water treated man-made vitreous fibres manufactured as described herein. These are suitable ways to store the MMVF for use.

The invention relates to a method of manufacturing a man-made vitreous fibre element (MMVF element), comprising
i. providing water treated man-made vitreous fibres (MMVF) manufactured as described herein
ii. providing a binder,
iii. applying the binder to the MMVF to form a mixture,
iv. shaping the mixture,
v. curing the mixture to form the MMVF element.

It is an advantage of the invention that the water treated MMVF can be used to make a MMVF element with improved properties. An advantage is that less binder is required when the MMVF are used to form a MMVF element, whilst maintaining the strength, such as the aged bending strength of the MMVF element. As a result, the amount of binder used in MMVF elements can be reduced while maintaining or improving the aged bending strength. The density of MMVF elements can therefore be reduced which saves on raw materials, transportation costs and reduces the weight of the building project. Further, the MMVF elements have an increased aged bending strength.

The fire class of the MMVF elements can be increased as less binder is required which means the amount of flammable material is reduced.

Preferably, step i comprises providing the water treated MMVF from a bale, mat or collection of loose fibres manufactured as described herein.

It is an advantage that MMVF can be stored and then used to make an MMVF element. Preferably, loose fibres and tufts may be directly used in the process.

Preferably, the method comprises processing the water treated MMVF from a bale into tufts. This makes it easier to distribute the MMVF in the MMVF element. Preferably the MMVF in the bales are subject to a disentanglement process as described herein.

Preferably, in step v, the mixture is cured by applying heat and/or pressure. This has the advantage of increasing the strength of the MMVF element.

Preferably, in step v, the mixture is cured at a temperature of about 200° C. to about 400° C., preferably about 225° C. to about 300° C.

Preferably, in step v, the mixture is cured at a pressure of about 15 bar to about 20 bar, preferably about 16 bar to about 18 bar, preferably about 17.5 bar.

Preferably, the binder is a phenol formaldehyde based binder.

Preferably, the MMVF element has a density in the range of about 900 kg/m³ to about 1400 kg/m³, preferably about 1000 kg/m³ to about 1300 kg/m³, preferably about 1050 kg/m³ to about 1200 kg/m³, preferably a density of about 1100 kg/m³ to about 1150 kg/m³. Such densities are particularly suitable for MMVF elements used as insulation materials or as cladding for a building. It is particularly advantageous that the density of the MMVF element falls within these ranges as surprisingly, the water treated MMVF give the resulting MMVF element a higher aged bending strength. It is desirable to reduce the weight of the MMVF element, whilst maintaining the aged bending strength and the MMVF element and this is shown in the present invention. The density of the MMVF element may be reduced by reducing the amount of binder used. This in turn improves the fire class of the MMVF element by reducing the amount of the flammable binder present.

Preferably, the method comprises applying about 5 wt % to about 15 wt % binder, based on the weight of the MMVF, preferably about 10 wt % to about 12 wt % binder. This amount of binder helps balance the density, aged bending strength and fire class of the MMVF element.

Preferably, the MMVF element has a loss on ignition (LOI) of about 5 wt % to about 15 wt %, preferably about 10 wt % to about 12 wt %. The LOI relates to the amount of binder in the MMVF element. This amount of binder helps balance the density, aged bending strength and fire class of the MMVF element.

Determination of the LOI and thus binder content is performed according to Table 2, No. 6 of EAD 090001-00-0404, dated May 2015 by heating a sample at 650 C for at least 1 hour. The percentage weight difference before and after the heat treatment is the LOI.

Preferably, the MMVF element has an aged bending strength of at least about 19 N/mm², preferably about 22 N/mm², preferably in the range of about 22 N/mm² to about 30 N/mm², preferably about 25 N/mm² to about 30 N/mm². Such aged bending strengths are suitable for insulation materials and cladding. Aged bending strength and initial bending strength can be measured in accordance with EAD 090001-01-0404 Prefabricated compressed mineral wool boards.

Preferably, the thickness of the MMVF element is in the range of about 5 mm to about 60 mm, preferably in the range of about 5 mm to about 30 mm, preferably in the range of about 5 mm to about 20 mm, preferably in the range of about 10 mm to about 20 mm;

Preferably, the MMVF element has a width and length each independently in the range of about 20 cm to about 4 m, preferably in the range of about 50 cm to about 3.5 m, preferably in the range of about 1 m to about 3 m.

Preferably, the MMVF element is a plate, preferably a board, a panel, or a slab.

Preferably, the MMVF element is used as an insulation material, or for cladding.

### EXAMPLES

### Example 1

The properties of water treated MMVF according to the invention (Group 2) were compared with those of control MMVF which were not water treated (Group 1).

Method of Making MMVF in Group 1

A combination of basalt, recycled stone wool and raw material additives was heated to a temperature of about 1500° C.. The molten material was then poured onto cascade spinning wheels to create MMVF that were quenched in an air flow. Subsequently, the MMVF in the form of tufts were collected on a conveyer. The MMVF of Group 1 were not sprayed with water and were formed into bales and stored for 4 to 6 weeks.

Method Making MMVF in Group 2

A combination of basalt, recycled stone wool and raw material additives was heated to a temperature of about 1500° C.. The molten material was then poured onto cascade spinning wheels to create MMVF that were quenched in an air flow. Subsequently, the MMVF in the form of tufts were collected on a conveyer. The MMVF of Group 2 were then sprayed with 0.3 wt % water, based on the weight of MMVF using two groups of electrically actuated hydraulic nozzles with two nozzles each, spraying the top surface before and after tumbling the MMVF tufts, respectively. Subsequently, the MMVF tufts were formed into bales and stored for 4 to 6 weeks.

Method of Making a MMVF Element

The bales were then separated into flocks of MMVF and about 12 wt % of a phenol formaldehyde based binder was added to the MMVF to form a mixture. On the press line, the mixture was pressed at 17 bar into an 8 mm board and cured at a temperature of 235° C. at 100 mm/s line speed resulting in a core temperature of 200° C. to form a MMVF element. The element was a panel of approximately 8 mm thickness.

Measurements

The loss on ignition, aged bending strength, initial bending strength, density, and thickness of the MMVF element formed using MMVF of Group 1 or Group 2 were measured and the results are shown in Table 1. The median test p-value was 0.000 in all measurements.

TABLE 1

| | Group | Median | Number of test samples |
|---|---|---|---|
| Aged Strength | 1 | 25.87 | 2484 |
| N/mm² | 2 | 28.39 | 2220 |
| Initial Strength | 1 | 37.32 | 4970 |
| N/mm² | 2 | 35.54 | 4450 |
| Density | 1 | 1152 | 7455 |
| kg/m³ | 2 | 1118 | 6675 |
| Thickness | 1 | 7.88 | 7455 |
| mm | 2 | 7.95 | 6675 |
| LOI | 1 | 12.42 | 4970 |
| % | 2 | 11.91 | 4410 |

The results show that the loss on ignition was lower for the water treated MMVF elements than the control MMVF elements. This shows that less binder was used in the water treated MMVF element which reduces the amount of flammable material present.

The initial bending strength of the control MMVF element was higher than the water treated MMVF elements, however, surprisingly, the aged bending strength was higher for the water treated MMVF elements. This suggests that the water treated MMVF elements have greater stability as there is a lower loss of bending strength and a higher aged bending strength. Furthermore, it is advantageous that the aged bending strength is higher.

The density of the control MMVF elements is higher than the density of the water treated MMVF elements. It is surprising therefore, that in spite of a lower density, the water treated MMVF elements have a higher aged bending strength than the control MMVF elements.

Overall, the water treated MMVF element had a lower density, a lower loss on ignition, a shorter conditioning time and a higher aged bending strength which evidences the superior properties of the water treated MMVF of the present invention.

### Example 2

Experiments were carried out to compare the effect of water treatment and storage time.

Method of Making a MMVF Element

A combination of basalt, recycled stone wool and raw material additives was heated to a temperature of about 1500° C.. The molten material was then poured onto cascade spinning wheels to create MMVF that were quenched in an air flow. Subsequently, the MMVF in the form of tufts were collected on a conveyer. The MMVF tufts were then sprayed with water, as set out in Table 2, using two groups of electrically actuated hydraulic nozzles with two nozzles each, spraying the top surface before and after tumbling the MMVF tufts, respectively. Subsequently, the MMVF were formed into bales and stored as set out in Table 2. The MMVF element was then formed as set out for Example 1.

Measurements

The aged strength, storage time and amount of water used are shown in Table 2. The loss on ignition, aged bending strength, initial bending strength, density, and thickness of the MMVF element were measured and the results are shown in Table 2.

TABLE 2

| | Water % | | | | | | |
|---|---|---|---|---|---|---|---|
| | based on | | | | | Initial | Aged |
| | the weight | Storage | Thickness | Density | | Strength | Strength |
| Item | of MMVF | weeks | mm | kg/m³ | LOI % | N/mm² | N/mm² |
| A | 0.340 | 2 | 7.95 | 1119 | 11.82 | 33.72 | 26.03 |
| B | 0.640 | 2 | 7.96 | 1134 | 11.92 | 35.36 | 28.32 |
| C | 0.340 | 4 | 7.92 | 1128 | 11.89 | 36.73 | 29.80 |
| D | 0.640 | 4 | 7.99 | 1142 | 12.01 | 35.87 | 28.86 |

The results show that increasing storage period from 2 to 4 weeks has a strong beneficial effect on strength in the case of low water-spraying (0.34%), while the effect is not significant in the case of increased water-spraying (0.64%). Similarly, increasing water-spraying from 0.34% to 0.64% has a significant effect on strength in the case of 2-week storage, but no significant effect after 4-week storage. The term “significant” refers to statistically significance with 95% confidence in the case of comparing the corners of the experimental design (Mann-Whitney test).

The maximum achievable strength by either water-spraying or storage time cannot lead to a performance above the physical maximum defined strength. Consequently, the effect of increasing water-spraying fades out with increasing storage time and vice versa. In other words, water-spraying enhances the conditioning of wool that takes place during storage. Notice, that the above conclusions apply to increasing water-spraying. The effect of water-spraying compared to no water-spraying is significant and shown in Example 1.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein and vice versa.

Within this specification, the term “about” means plus or minus 20%, more preferably plus or minus 10%, even more preferably plus or minus 5%, most preferably plus or minus 2%.

Within this specification, the term “substantially” means a deviation of plus or minus 20%, more preferably plus or minus 10%, even more preferably plus or minus 5%, most preferably plus or minus 2%.

Within this specification, reference to “substantially” includes reference to “completely” and/or “exactly”. That is, where the word substantially is included, it will be appreciated that this also includes reference to the particular sentence without the word substantially.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1. A method for manufacturing water treated man-made vitreous fibres (MMVF) comprising:
a. providing a mineral melt,
b. providing a fiberizing apparatus,
c. fiberizing the mineral melt to form man-made vitreous fibres (MMVF),
d. collecting the MMVF, and thereafter
e. applying about 0.1 wt % to about 1 wt % water, based on the weight of MMVF, to the MMVF to form water treated MMVF.

2. The method according to claim 1, wherein in step e, the temperature of the MMVF is in the range of about 10° C. to about 100° C., preferably about 30° C. to about 90° C., preferably about 50° C. to about 80° C., and/or
wherein in step e, the temperature of the water is in the range of about 10° C. to about 100° C.,
preferably about 30° C. to about 90° C., preferably about 50° C. to about 80° C.

3. The method according to claim 1, wherein step e comprises applying about 0.2 wt % to about 0.8 wt % water, based on the weight of the MMVF, to the MMVF to form water treated MMVF, preferably about 0.3 wt % to about 0.5 wt % water.

4. The method according to claim 1, wherein in step d, the MMVF are in the form of:
a) web, preferably wherein the web has a thickness in the range of about 5 cm to about 30 cm, preferably about 10 cm to about 20 cm, or
b) tufts, or
c) loose fibres.

5. The method according to claim 1, wherein in step e, the water is applied by spraying, preferably using a piezoelectric sprayer, an electrostatic sprayer, an ultrasonic sprayer, or a pressure sprayer; and/or
wherein the water is treated water, preferably chemically and/or physically treated water, preferably filtered or purified water, preferably ion-exchange water; and/or
wherein the water is in the form of droplets, preferably wherein the droplet size is about 10 μm to about 500 μm, preferably about 100 μm to about 300 μm.

6. The method according to claim 1, wherein after step d and before and/or during step e, the MMVF are subjected to a disentanglement process, preferably wherein the disentanglement process is an airstream, preferably wherein the airstream has an airflow of from about 1 m/s to about 150 m/s, preferably about 5 m/s to about 80 m/s.

7. The method according to claim 1, further comprising f: forming the water treated MMVF into a bale.

8. The method according to claim 1, further comprising storing the MMVF for at least about 1 day, preferably about one day to about six weeks, preferably about 3 days to about 3 weeks.

9. The method according to claim 8, comprising storing the MMVF at a temperature in the range of about 10° C. to about 100° C., preferably about 20° C. to about 75° C., preferably about 20° C. to about 50° C.; and/or
comprising storing the MMVF at an absolute humidity of about 1.8 g/m³ to about 600 g/m³, preferably about 5 g/m³ to about 200 g/m³.

10. The method according to claim 1, wherein a binder is not used therein.

11. The bale, mat or collection of loose fibres comprising water treated man-made vitreous fibres manufactured according to claim 1.

12. A method of manufacturing a man-made vitreous fibre element (MMVF element), comprising:
i. providing water treated man-made vitreous fibres (MMVF) manufactured according to claim 1,
ii. providing a binder,
iii. applying the binder to the MMVF to form a mixture,
iv. shaping the mixture, and
v. curing the mixture to form the MMVF element.

13. The method according to claim 12, comprising processing the water treated MMVF from a bale into tufts.

14. The method according to claim 12, wherein the MMVF element has a density in the range of about 900 kg/m³ to about 1400 kg/m³, preferably about 1000 kg/m³ to about 1300 kg/m³, preferably about 1050 kg/m³ to about 1200 kg/m³, preferably a density of about 1100 kg/m³ to about 1150 kg/m³, and/or
further comprising applying about 5 wt % to about 15 wt % binder, based on the weight of the MMVF, preferably about 10 wt % to about 12 wt % binder.

15. The method according to claim 12, wherein the MMVF element has an aged bending strength of at least about 19 N/mm², preferably about 22 N/mm², preferably in the range of about 22 N/mm² to about 30 N/mm², preferably about 25 N/mm² to about 30 N/mm².

16. The method according to claim 12, wherein the thickness of the MMVF element is in the range of about 5 mm to about 60 mm, preferably in the range of about 5 mm to about 30 mm, preferably in the range of about 5 mm to about 20 mm, preferably in the range of about 10 mm to about 20 mm; and/or
wherein the MMVF element is a plate, preferably a board, a panel, or a slab.
